(19) United States
(12) Patent Application Publication
(10) Pub. No.: US 2016/0256239 A1
(43) Pub. Date: Sep. 8, 2016

(54) Mouth Guard Assembly

(71) Applicant: Amy Nolte, Richmond, IN (US)

(72) Inventor: Amy Nolte, Richmond, IN (US)

(21) Appl. No.: 14/640,112

(22) Filed: Mar. 6, 2015

(51) Int. Cl. A61C 7/08

(52) U.S. Cl. CPC A61C 7/08

(57) ABSTRACT

A mouth guard assembly for includes a teeth protection apparatus that may be worn within a mouth of a user while the user engages in athletic activity. The teeth protection apparatus covers an upper row of teeth of the user and the teeth protection apparatus surrounds an upper surface and a lower surface of an orthodontic device on the upper row of teeth. The teeth protection apparatus protects the orthodontic device from impact damage.

### BACKGROUND OF THE DISCLOSURE

1. Field of the Disclosure

The disclosure relates to guard devices and more particularly pertains to a new guard device for protecting an orthodontic device from impact damage.

2. Summary of the Disclosure

An embodiment of the disclosure meets the needs presented above by generally comprising a teeth protection apparatus that may be worn within a mouth of a user while the user engages in athletic activity. The teeth protection apparatus covers an upper row of teeth of the user and the teeth protection apparatus surrounds an upper surface and a lower surface of an orthodontic device on the upper row of teeth. The teeth protection apparatus protects the orthodontic device from impact damage.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a mouth guard assembly according to an embodiment of the disclosure.

FIG. 2 is a left side view of an embodiment of the disclosure.

FIG. 3 is a top view of an embodiment of the disclosure.

FIG. 4 is a cross sectional view taken along line 4-4 of FIG. 3 of an embodiment of the disclosure.

FIG. 5 is a cross sectional view taken along line 5-5 of FIG. 4 of an embodiment of the disclosure.

FIG. 6 is a perspective in-use view of an embodiment of the disclosure.

### DESCRIPTION OF THE PREFERRED EMBODIMENT

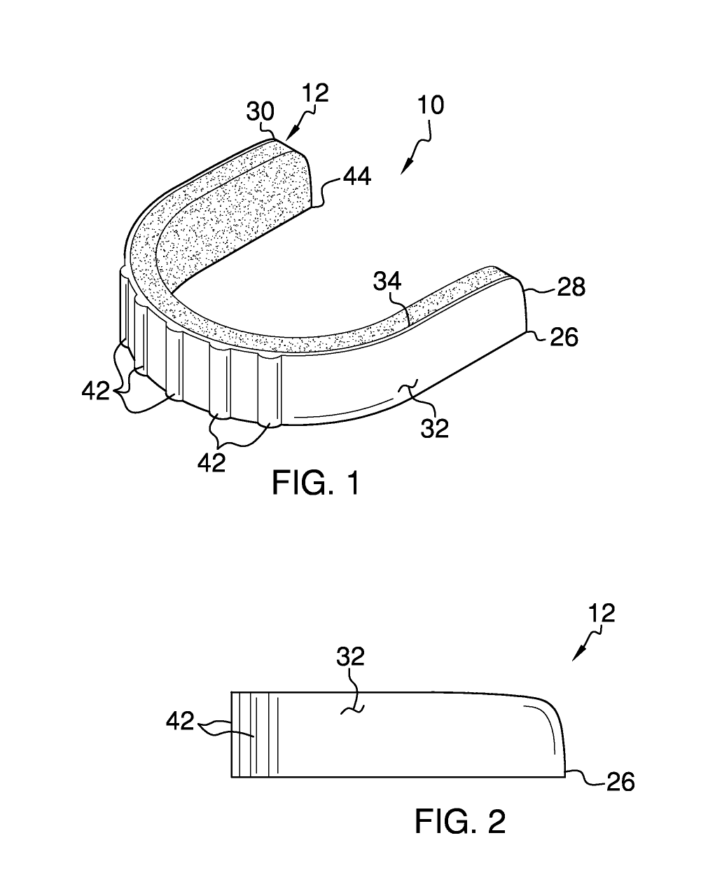

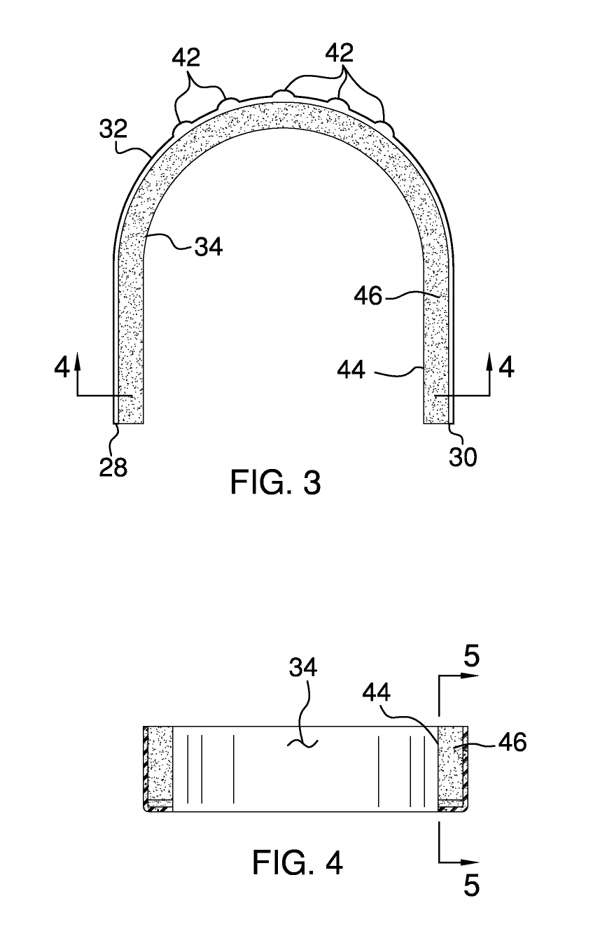

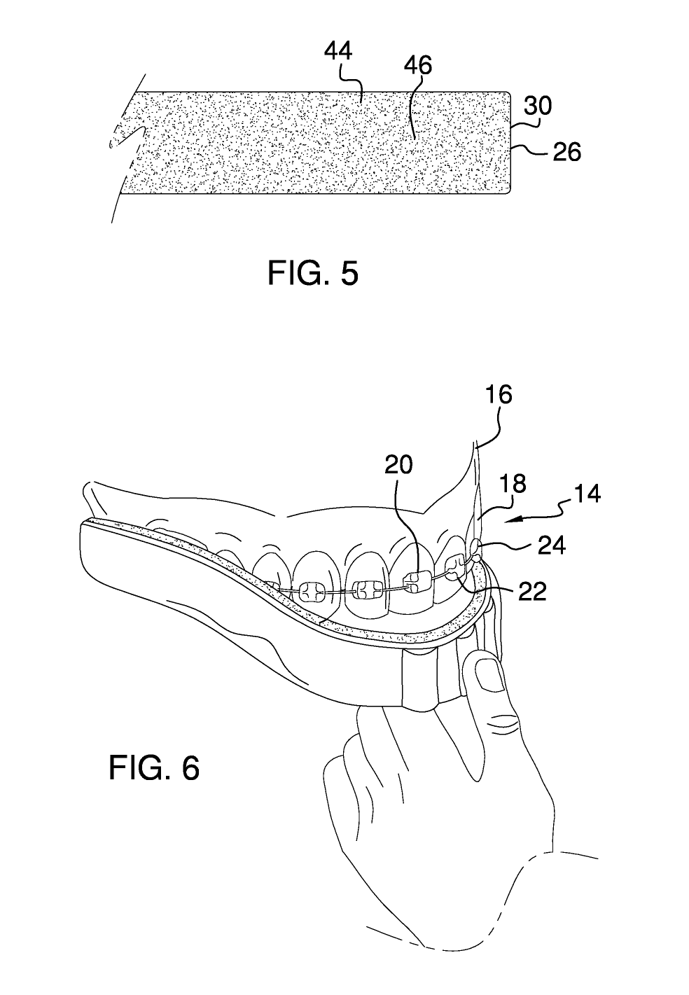

With reference now to the drawings, and in particular to FIGS. 1 through 6 thereof, a new guard device embodying the principles and concepts of an embodiment of the disclosure and generally designated by the reference numeral 10 will be described.

As best illustrated in FIGS. 1 through 6, the mouth guard assembly 10 generally comprises a teeth protection apparatus 12 that may be worn within a mouth 14 of a user 16 while the user 16 engages in athletic activity. The teeth protection apparatus 12 covers an upper row of teeth 18 of the user 16 to surround an upper surface 20 and a lower surface 22 of an orthodontic device 24 on the upper row of teeth 18 thereby protecting the orthodontic device 24. The orthodontic device 24 may be braces or the like.

The teeth protection apparatus 12 comprises a guard 26 that has a first end 28, a second end 30, a front surface 32 and a back surface 34. The guard 26 is arcuate between the first end 28 and the second end 30 such that the guard 26 is U-shaped. The guard 26 may be positioned within the user's mouth 14 such that the guard 26 is coextensive with upper row of the user's teeth 18. A cushion 44 is provided and the cushion 44 is attached to the guard 26. The cushion 44 is positioned on the back surface 34 and the cushion 44 extends substantially between the first end 28 and the second end 30. The cushion 44 abuts the upper row of the user's teeth 18 when the guard is positioned within the user's mouth 14 and protects the orthodontic device 24 from impact damage. The cushion 44 contains a gel 46 such that the cushion 44 may absorb impact energy.

A plurality of bumpers 42 is provided and the bumpers 42 are attached to the guard 26. Each of the bumpers 42 is positioned on the front surface 32 and the bumpers 42 are spaced apart from each other. The bumpers 42 are centrally positioned between the first end 28 and the second end 30 and the bumpers 42 are convexly arcuate with respect to the front surface 32. The bumpers 42 are compressible toward the front surface 32 such that the bumpers 42 may absorb impact energy.

In use, the guard 26 is placed within the user's mouth 14 so the cushion 44 abuts the upper row of user's teeth 18 and the orthodontic device 24. The user 16 wears the guard 26 when the user 16 participates in an athletic activity or other activity that carries a risk of impact damage to the orthodontic device 24. The cushion 44 and the bumpers 42 absorb impact force that would otherwise be transferred to the upper row of the user's teeth 18. Additionally, the cushion 44 prevent the orthodontic device 24 from damaging the user's mouth 14 when the user 16 is exposed to impact force and the cushions 44 and the bumpers 42 prevents the orthodontic device 24 from being damaged by the impact force.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A mouth guard assembly configured to accommodate an orthodontic device, said assembly comprising:
a teeth protection apparatus configured to be worn within a mouth of a user while the user engages in athletic activity such that said teeth protection apparatus covers an upper row of teeth of the user, said teeth protection apparatus being positioned against an orthodontic device on the upper row of teeth such that the orthodontic device is protected from impact damage.

2. The assembly according to claim 1, wherein said teeth protection apparatus comprises a guard having a first end, a second end, a front surface and a back surface, said guard being arcuate between said first end and said second end such that said guard is U-shaped.

3. The assembly according to claim 2, further comprising a cushion being attached to said guard, said cushion being positioned on said back surface, said cushion extending substantially between said first end and said second end, said cushion being configured to abut the top row of the user's teeth when said guard is positioned within the user's mouth thereby protecting the orthodontic device from impact damage.

4. The assembly according to claim 2, further comprising a plurality of bumpers attached to said guard, each of said bumpers being positioned on said front surface, said bumpers being spaced apart from each other, said bumpers being centrally positioned between said first end and said second end, said bumpers being convexly arcuate with respect to said front surface, said bumpers being compressible against said front surface such that said bumpers are configured to absorb impact energy.

5. A mouth guard assembly configured to accommodate an orthodontic device, said assembly comprising:
a teeth protecting apparatus configured to be worn within a mouth of a user while the user engages in athletic activity such that said teeth protecting apparatus covers an upper row of teeth of the user, said teeth protecting apparatus being positioned above an upper surface and below a lower surface of an orthodontic device on the upper row of teeth such that the orthodontic device is protected from impact damage, said teeth protecting apparatus comprising:
a guard having a first end, a second end, a front surface and a back surface, said guard being arcuate between said first end and said second end such that said guard is U-shaped, said guard being configured to be positioned within the user's mouth such that said guard is coextensive with upper row of the user's teeth;
a cushion being attached to said guard, said cushion being positioned on said back surface, said cushion extending substantially between said first end and said second end, said cushion being configured to abut the top row of the user's teeth when said guard is positioned within the user's mouth thereby protecting the orthodontic device from impact damage; and
a plurality of bumpers attached to said guard, each of said bumpers being positioned on said front surface, said bumpers being spaced apart from each other, said bumpers being centrally positioned between said first end and said second end, said bumpers being convexly arcuate with respect to said front surface, said bumpers being compressible against said front surface such that said bumpers are configured to absorb impact energy.
